(19) United States
(12) Patent Application Publication
(10) Pub. No.: US 2025/0246202 A1
(43) Pub. Date: Jul. 31, 2025

(54) ELECTRONIC DEVICE AND CONTROL METHOD THEREOF

(71) Applicants: Hyundai Motor Company, Seoul (KR); Kia Corporation, Seoul (KR)

(72) Inventor: Yu Jung Chae, Seoul (KR)

(21) Appl. No.: 18/741,267

(22) Filed: Jun. 12, 2024

(30) Foreign Application Priority Data
Jan. 30, 2024 (KR) 10-2024-0014163

(51) Int. Cl. G10L 25/90; G10L 13/08; G10L 15/04; G10L 15/06

(52) U.S. Cl. CPC G10L 25/90; G10L 13/08; G10L 15/04; G10L 15/063

(57) ABSTRACT

In an electronic device, and control method thereof, at least one processor can identify a first word segment being a first unit on grammar and a second word segment being a second unit on grammar from a target sentence included in a corpus, determine a target phrase including the first word segment and the second word segment, based on comparing a pause time between the first word segment and the second word segment and a threshold time, and determine a change in voice tone in the target phrase, based on information about a pitch contour of voice data obtained by applying the target sentence to a text-to-speech model and an utterance time of each word segment included in the target phrase. Thereby, the device can determine a gesture of a robot while outputting the target sentence.

### CROSS-REFERENCE TO RELATED APPLICATIONS

This application claims the benefit of priority to Korean Patent Application No. 10-2024-0014163, filed in the Korean Intellectual Property Office on Jan. 30, 2024, the entire contents of which are incorporated herein by reference.

### TECHNICAL FIELD

The present disclosure relates to generating robot gestures based on text phrases.

### BACKGROUND

To generate a speech-gesture of a robot, which corresponds to an utterance text of the robot, which is received from a conversation model (e.g., a chatbot), there is a need for a process of selecting and generating an interval (e.g., including start and end time points of a gesture) to which the gesture is able to be assigned and a gesture suitable for the gesture assignment interval from a database, in a given robot utterance text. In detail, when the gesture is assigned to the entire utterance text, because the gesture is represented from an utterance start time point to an utterance end time point, this may hinder user immersion. Furthermore, when time synchronization (Sync) between a robot utterance and a gesture is not correct, this may cause a negative interaction effect between a person and a robot (e.g., a decrease in favorability).

In this regard, the interval to which the gesture is able to be assigned may vary for each word segment or each phrase. However, because the word segment has a short utterance time, it is difficult to secure a time enough to generate a gesture. Thus, technologies for assigning a gesture to phrase units have mainly been developed, However, because the technologies generate a gesture based on grammar information (e.g. parts of speech) or semantic information (e.g. morphemes) in the utterance text, connectivity with changes in voice tone is not considered. Furthermore, because using a model trained using a machine learning method requires a process in which a user constructs a huge amount of data, there is the difficulty of having to require time and effort.

To address such a problem, there is a need to develop a technology for automatically generating training data of a model for generating a robot gesture and a technology for assigning a gesture based on a change in voice tone.

### SUMMARY

The present disclosure relates to generating robot gestures based on text phrases. The present disclosure relates to an electronic device and a control method thereof, and more particularly, relates to technologies for generating training data of a model which generates a robot gesture.

Some embodiments of the present disclosure can solve the above-mentioned problems occurring in the prior art while advantages achieved by the prior art are maintained intact.

An embodiment of the present disclosure can provide an electronic device for determining a change in voice tone in a target phrase, based on information about a pitch contour of voice data obtained by applying a target sentence to a text-to-speech model and an utterance time of each of word segments to generate a gesture suitable for an utterance of a robot based on the change in voice tone and a control method thereof.

An embodiment of the present disclosure can provide an electronic device for applying cubic spline interpolation to voice data to obtain information about a pitch contour, based on not identifying the information about the pitch contour from voice data to obtain a change in voice tone in a word phrase in which the pitch contour is not identified and a control method thereof.

An embodiment of the present disclosure can provide an electronic device for determining a phrase with the largest change in voice tone among phrases included in a target sentence as a gesture assignment candidate of the target sentence to provide natural interaction with a user by use of natural speech-gesture generation of a robot and a control method thereof.

Technical problems to be solved by some embodiments of the present disclosure are not limited to the aforementioned problems, and other technical problems not mentioned herein can be solved by some embodiments of the present disclosure, which can be understood from the following description by those skilled in the art to which the present disclosure pertains.

According to an embodiment of the present disclosure, an electronic device may include a memory storing computer-executable instructions and at least one processor that accesses the memory and executes the instructions. The at least one processor may identify a first word segment being a unit on grammar and a second word segment being a unit on grammar from a target sentence included in a corpus, may determine a target phrase including the first word segment and the second word segment, based on comparison between a pause time between the first word segment and the second word segment and a set or predetermine threshold time, and may determine a change in voice tone in the target phrase, based on information about a pitch contour of voice data obtained by applying the target sentence to a selected, set, or predetermined text-to-speech model and an utterance time of each of the word segments included in the target phrase.

In an embodiment, the at least one processor may identify a first utterance time of the first word segment and a second utterance time of the second word segment from the voice data, may determine a first change in voice tone in the first word segment by use of the first utterance time and information about a pitch contour of the first word segment, and may determine a second change in voice tone in the second word segment by use of the second utterance time and information about a pitch contour of the second word segment.

In an embodiment, the at least one processor may obtain a rate of change in voice tone at intervals of a set or predetermined unit time from the information about the pitch contour of the first word segment corresponding to the first utterance time to determine the first change in voice tone and may obtain a rate of change in voice tone at intervals of the set or predetermined unit time from the information about the pitch contour of the second word segment corresponding to the second utterance time to determine the second change in voice tone.

In an embodiment, the at least one processor may determine an average of the first change in voice tone and the second change in voice tone, based on that the first word segment and the second word segment are included in the target phrase and may determine a value obtained by applying the average to a normalization function as the change in voice tone in the target phrase.

In an embodiment, the at least one processor may include the first word segment and the second word segment in the target phrase, based on that the pause time is less than the threshold time, and may include one of the first word segment or the second word segment in the target phrase, based on that the pause time is greater than or equal to the threshold time.

In an embodiment, the at least one processor may determine positions of the first word segment and the second word segment in the voice data, based on that the pause time is less than the threshold time, may identify a third word segment subsequent to the second word segment from the voice data, based on the second word segment is subsequent to the first word segment, and may determine whether to include the third word segment in the target phrase, based on comparison between a pause time between the second word segment and the third word segment and the threshold time.

In an embodiment, the at least one processor may obtain a first target vector with the number of selected, set, or predetermined dimensions, by use of word embedding of a target window including the first word segment and the second word segment, may apply the first target vector to a phrase unit recognition model to obtain an output indicating whether to perform segmentation of the word segments included in the target window, and may train the phrase unit recognition model, based on a first loss obtained by use of comparison between the output and the target sentence.

In an embodiment, the at least one processor may obtain a second target vector including vectors with the number of selected, set, or predetermined dimensions for every word segment included in the target phrase, by use of word embedding of the target phrase, may apply the second target vector to an encoder for reducing a dimension of an input target to reduce a dimension of the second target vector, may apply the second target vector applied to the encoder to a voice tone change prediction model to obtain a temporary change in voice tone in the target phrase, and may train the voice tone change prediction model, based on a second loss obtained by use of comparison between the temporary change in voice tone in the target phrase and the change in voice tone in the target phrase.

In an embodiment, the at least one processor may determine a phrase with a largest change in voice tone among phrases included in the target sentence as a gesture assignment candidate corresponding to a gesture execution interval of the target sentence, based on a change in voice tone in each of the phrases included in the target sentence being determined, may determine a gesture of the gesture assignment candidate, based on a gesture type corresponding to the gesture assignment candidate, and may allow the gesture to correspond to an utterance time of the gesture assignment candidate to generate a gesture of a robot scheduled to output the target sentence.

In an embodiment, the at least one processor may apply cubic spline interpolation to the voice data to identify the information about the pitch contour, based on not identifying the information about the pitch contour from the voice data.

According to an embodiment of the present disclosure, a control method may include identifying a first word segment being a unit on grammar and a second word segment being a unit on grammar from a target sentence included in a corpus, determining a target phrase including the first word segment and the second word segment, based on comparison between a pause time between the first word segment and the second word segment and a selected, set, or predetermined threshold time, and determining a change in voice tone in the target phrase, based on information about a pitch contour of voice data obtained by applying the target sentence to a selected, set, or predetermined text-to-speech model and an utterance time of each of the word segments included in the target phrase.

In an embodiment, the determining of the target phrase may include identifying a first utterance time of the first word segment and a second utterance time of the second word segment from the voice data, determining a first change in voice tone in the first word segment by use of the first utterance time and information about a pitch contour of the first word segment, and determining a second change in voice tone in the second word segment by use of the second utterance time and information about a pitch contour of the second word segment.

In an embodiment, the determining of the target phrase may include obtaining a rate of change in voice tone at intervals of a selected, set, or predetermined unit time from the information about the pitch contour of the first word segment corresponding to the first utterance time to determine the first change in voice tone and obtaining a rate of change in voice tone at intervals of the selected, set, or predetermined unit time from the information about the pitch contour of the second word segment corresponding to the second utterance time to determine the second change in voice tone.

In an embodiment, the determining of the change in voice tone in the target phrase may include determining an average of the first change in voice tone and the second change in voice tone, based on that the first word segment and the second word segment are included in the target phrase, and determining a value obtained by applying the average to a normalization function as the change in voice tone in the target phrase.

In an embodiment, the determining of the target phrase may include including the first word segment and the second word segment in the target phrase, based on that the pause time is less than the threshold time, and including one of the first word segment or the second word segment in the target phrase, based on that the pause time is greater than or equal to the threshold time.

In an embodiment, the determining of the target phrase may include determining positions of the first word segment and the second word segment in the voice data, based on that the pause time is less than the threshold time, identifying a third word segment subsequent to the second word segment from the voice data, based on the second word segment is subsequent to the first word segment, and determining whether to include the third word segment in the target phrase, based on comparison between a pause time between the second word segment and the third word segment and the threshold time.

In an embodiment, the control method may further include obtaining a first target vector with the number of selected, set, or predetermined dimensions, by use of word embedding of a target window including the first word segment and the second word segment, applying the first target vector to a phrase unit recognition model to obtain an output indicating whether to perform segmentation of the word segments included in the target window, and training the phrase unit recognition model, based on a first loss obtained by use of comparison between the output and the target sentence.

In an embodiment, the control method may further include obtaining a second target vector including vectors with the number of selected, set, or predetermined dimensions for every word segment included in the target phrase, by use of word embedding of the target phrase, applying the second target vector to an encoder for reducing a dimension of an input target to reduce a dimension of the second target vector, applying the second target vector applied to the encoder to a voice tone change prediction model to obtain a temporary change in voice tone in the target phrase, and training the voice tone change prediction model, based on a second loss obtained by use of comparison between the temporary change in voice tone in the target phrase and the change in voice tone in the target phrase.

In an embodiment, the control method may further include determining a phrase with a largest change in voice tone among phrases included in the target sentence as a gesture assignment candidate corresponding to a gesture execution interval of the target sentence, based on that a change in voice tone in each of the phrases included in the target sentence is determined, determining a gesture of the gesture assignment candidate, based on a gesture type corresponding to the gesture assignment candidate, and allowing the gesture to correspond to an utterance time of the gesture assignment candidate to generate a gesture of a robot scheduled to output the target sentence.

In an embodiment, the control method may further include applying cubic spline interpolation to the voice data to identify the information about the pitch contour, based on not identifying the information about the pitch contour from the voice data.

### BRIEF DESCRIPTION OF THE DRAWINGS

The above and other features and advantages of the present disclosure can be more apparent from the following detailed description taken in conjunction with the accompanying drawings, in which:

FIG. 1 is a drawing illustrating an electronic device according to an embodiment of the present disclosure;

FIG. 2 is a flowchart for describing a control method according to an embodiment of the present disclosure;

FIG. 3 is a drawing illustrating a method for generating data for gesture training from a corpus, in an electronic device according to an embodiment of the present disclosure;

FIG. 4 is a drawing illustrating a method for identifying an utterance time of a word segment and a pause time between word segments, in an electronic device according to an embodiment of the present disclosure;

FIG. 5 is a drawing illustrating a method for determining a change in voice tone for each phrase, in an electronic device according to an embodiment of the present disclosure;

FIG. 6 is a drawing illustrating a method for generating a gesture from data for gesture training, in an electronic device according to an embodiment of the present disclosure;

FIG. 7 is a drawing illustrating a method for training a phrase unit recognition model, in an electronic device according to an embodiment of the present disclosure;

FIG. 8 is a drawing illustrating a method for training a voice tone change prediction model, in an electronic device according to an embodiment of the present disclosure;

FIG. 9 is a drawing illustrating a method for determining a gesture in a target sentence, in an electronic device according to an embodiment of the present disclosure; and

FIG. 10 is a drawing illustrating a computing system associated with an electronic device or a control method thereof according to an embodiment of the present disclosure.

With regard to description of drawings, same or similar denotations may be used for same or similar components.

### DETAILED DESCRIPTION OF ILLUSTRATIVE EMBODIMENTS

Hereinafter, some example embodiments of the present disclosure will be described in detail with reference to the example drawings. In adding reference numerals to the components of each drawing, it can be noted that the identical component can be designated by the identical numerals even when they are displayed on other drawings. In addition, a detailed description of well-known features or functions can be omitted to not unnecessarily obscure the gist of the present disclosure. Hereinafter, various example embodiments of the present disclosure may be described with reference to the accompanying drawings. However, it can be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of example embodiments of the present disclosure, the terms “first”, “second”, “A”, “B”, “(a)”, “(b)”, and the like, may be used herein. Such terms can be used merely to distinguish one component from another component, but do not necessarily limit the corresponding components irrespective of the order or priority of the corresponding components. Furthermore, unless otherwise defined, terms including technical and scientific terms used herein can have a same meaning as being generally understood by those skilled in the art to which the present disclosure pertains. Such terms as those defined in a generally used dictionary can be interpreted as having meanings equal to the contextual meanings in the relevant field of art, and are not to be interpreted as having ideal or excessively formal meanings unless clearly defined as having such in the present application. For example, the terms, such as “first”, “second”, “1st”, “2nd”, or the like can be used in the present disclosure to refer to various components regardless of the order and/or the priority and to distinguish one component from another component, but do not necessarily limit the components. For example, a first user device and a second user device indicate different user devices, irrespective of the order and/or priority. For example, without departing the scopes of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It can be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it can be understood that there is no intervening component (e.g., a third component).

According to the situation, the expression “configured to” used in the present disclosure may be used exchangeably with, for example, the expression “suitable for”, “having the capacity to”, “designed to”, “adapted to”, “made to”, or “capable of”.

The term “configured to” must not only mean “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in the disclosure can be used to describe specified example embodiments and are not intended to necessarily limit the scope of another embodiment. The terms of a singular form may include plural forms unless the context clearly indicates otherwise. Terms used herein, which include technical or scientific terms, may have a same meaning that is generally understood by a person skilled in the art described in the present disclosure. It can be further understood that terms, which are defined in a dictionary and commonly used, can also be interpreted as is customary in the relevant related art and not in an idealized or overly formal detect unless expressly so defined herein in various embodiments of the present disclosure. In some cases, even though terms are terms which are defined in the specification, they may not be interpreted to exclude embodiments of the present disclosure.

In the present disclosure, the expressions “A or B”, “at least one of A or/and B”, or “one or more of A or/and B”, and the like, may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

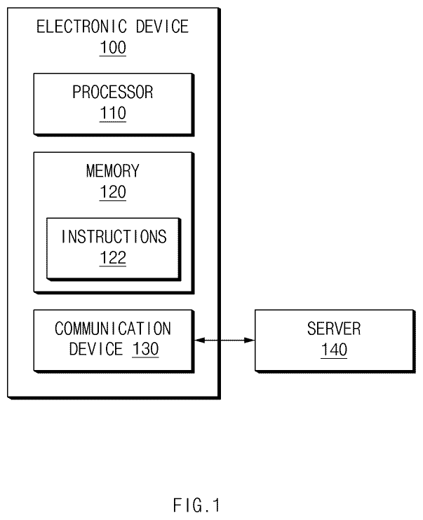

Hereinafter, example embodiments of the present disclosure will be described in detail with reference to FIGS. 1 to 10.

FIG. 1 is a drawing illustrating an electronic device according to an embodiment of the present disclosure.

An electronic device 100 according to an embodiment may include a processor 110, a memory 120 including instructions 122, and a communication device 130, communicating with a server 140, any combination of or all of which may be in plural or may include plural components thereof.

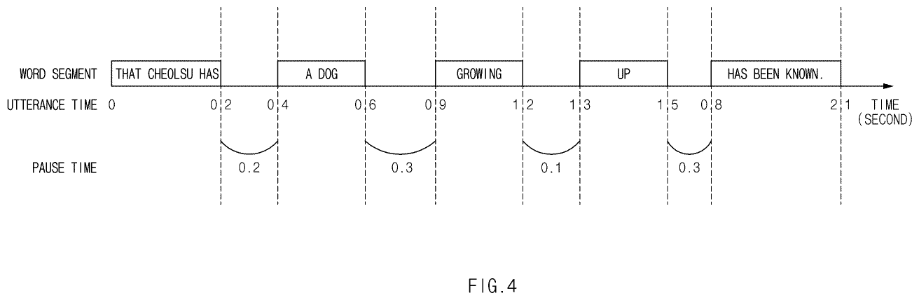

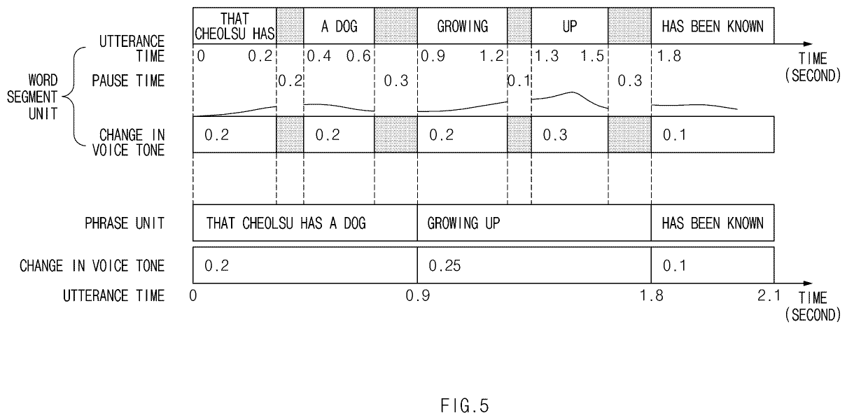

The electronic device 100 may indicate a device that generates training data of models about generation of a robot gesture. For example, the electronic device 100 may generate a target sentence, including a target phrase in which a change in voice tone is determined, as training data. In detail, the electronic device 100 may determine word segments to be included in the target phrase to determine a change in voice tone in the target phrase. The electronic device 100 may identify an utterance time of each of word segments and a pause time between the word segments to determine the word segments to be included in the target phrase. As a result, the electronic device 100 may determine the word segments to be included in the target phrase, based on the utterance time of each of the word segments and the pause time between the word segments. A detailed description of the method for determining the target phrase (i.e., determining the word segments to be included in the target phrase to determine the target phrase) will be described below with reference to FIGS. 4 and 5.

The word segment may indicate a phrase included in the target sentence. For example, the word segment may be a grammatical unit greater than a word and may include a phrase capable of being a space unit. The phrase may indicate a phrase included in the target sentence. For example, the phrase may include two or more word segments. The change in voice tone may indicate a change in utterance intensity and/or an utterance size of the word segment or the phrase. The target sentence may be raw data of training data of models about generation of a robot gesture. For example, the target sentence may be included in a corpus stored in a server 140. The target sentence may include a word segment and a phrase.

The processor 110 may execute software and may control at least one other component (e.g., a hardware or software component) connected with the processor 110. In addition, the processor 110 may perform a variety of data processing or calculation. For example, the processor 110 may store the word segment, the phrase, the change in voice tone, and the target sentence in the memory 120.

For reference, the processor 110 may perform all operations performed by the electronic device 100. Therefore, for convenience of description in the specification, the operation performed by the electronic device 100 is mainly described as an operation performed by the processor 110. Furthermore, for convenience of description in the specification, the processor 110 is mainly described as, but not limited to, one processor. For example, the electronic device 100 may include at least one processor. Each of the at least one processor may perform all operations associated with an operation of generating training data of a model for generating a robot gesture.

The memory 120 (storage medium) may temporarily and/or permanently store various pieces of data and/or information required to perform the operation of generating the training data of the model for generating the robot gesture. For example, the memory 120 may store the word segment, the phrase, the change in voice tone, and the target sentence.

The communication device 130 may assist in performing communication between the electronic device 100 and the server 140. For example, the communication device 130 may include one or more components for performing communication between the electronic device 100 and the server 140. For example, the communication device 130 may include a short range wireless communication unit, a microphone, or the like. A short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like, for example.

The server 140 may include the corpus. For example, the server 140 may transmit at least one of a plurality of sentences included in the corpus to the electronic device 100 in response to the request of the electronic device 100. The server 140 may receive pieces of data (e.g., pieces of data including a sentence) from various web servers to generate the corpus. In detail, the corpus may include various types of sentences and may include a large collection of sentences stored in a web cloud. To this end, the server 140 may generate the corpus including newspaper articles, community posts, and the like, by use of a web crawling technology.

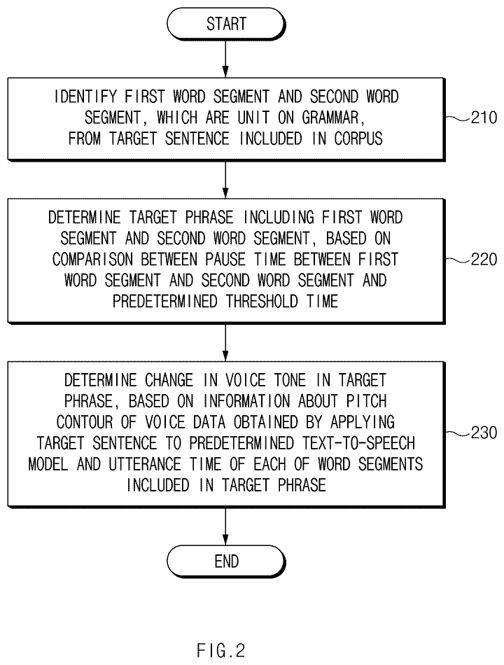

FIG. 2 is a flowchart for describing a control method according to an embodiment of the present disclosure.

In operation 210, an electronic device (e.g., an electronic device 100 of FIG. 1) according to an embodiment may identify a first word segment and a second word segment, which are a unit on grammar, from a target sentence included in a corpus. For example, the electronic device may receive the target sentence and/or the corpus from a server. When receiving the corpus, the electronic device may identify a sentence for training a model about generation of a robot gesture among a plurality of sentences included in the corpus as the target sentence. When identifying the target sentence, the electronic device may identify the first word segment and the second word segment from the target sentence. For reference, the first word segment and the second word segment may be word segments at positions, which are adjacent to each other, in the target sentence. However, it is not limited thereto. The first word segment and the second word segment may be segments at positions spaced apart from each other at a selected, set, or predetermined interval in the target sentence.

In operation 220, the electronic device may determine a target phrase including the first word segment and the second word segment, based on comparison between a pause time between the first word segment and the second word segment and a selected, set, or predetermine threshold time. For example, when the second word segment is located subsequent to the first word segment, the pause time may indicate a time from an end time point of an utterance time of the first word segment to a start time point of an utterance time of the second word segment. Furthermore, when the first word segment is located subsequent to the second word segment, the pause time may indicate a time from an end time point of the utterance time of the second word segment to a start time point of the utterance time of the first word segment. The electronic device may apply the first word segment and the second word segment to a text-to-speech model to identify the pause time between the first word segment and the second word segment. The electronic device may compare magnitudes of the pause time and the threshold time. Illustratively, when the pause time is smaller than the threshold time, the electronic device may include the first word segment and the second word segment in one target phrase. On the other hand, when the pause time is greater than the threshold time, the electronic device may include the first word segment and the second word segment in different phrases. A description will be given in detail below of the method for determining the target phrase by use of the comparison between the pause time and the threshold time with reference to FIG. 5.

In operation 230, the electronic device may determine a change in voice tone in the target phrase, based on information about a pitch contour of voice data obtained by applying the target sentence to the selected, set, or predetermined text-to-speech model and an utterance time of each of the word segments included in the target phrase. When text is input, the text-to-speech model may indicate a model that outputs a speech or a voice corresponding to the input text. In other words, the electronic device may apply the target sentence to the text-to-speech model to obtain voice data. However, the text-to-speech model is not limited thereto. For example, when text is input, the text-to-speech model may be a model that outputs phrases included in the input text and a change in voice tone in each of the phrases.

The electronic device may identify the information about the pitch contour of the voice data to obtain the change in voice tone. When identifying the information about the pitch contour of the voice data, the electronic device may determine a change in voice tone in the target phrase, based on the information about the pitch contour and the utterance time of each of the word segments. When the change in voice tone in the target phrase is determined, the electronic device may use the target sentence, including the target phrase in which the change in voice tone is determined, as training data of models for generating a robot gesture.

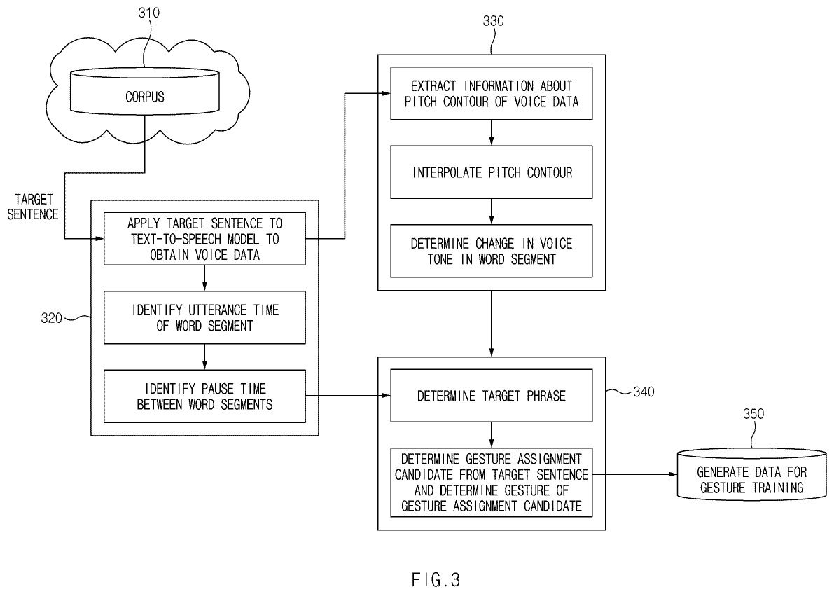

FIG. 3 is a drawing illustrating a method for generating data for gesture training from a corpus, in an electronic device according to an embodiment of the present disclosure.

An electronic device (e.g., an electronic device 100 of FIG. 1) according to an embodiment may include a first analysis device 320 about voice generation and an analysis of time for each word segment, a second analysis device 330 about an analysis of an utterance characteristic for each word segment, and a third analysis device 340 about an analysis of an utterance characteristic for each phrase. The electronic device may generate data 350 for gesture training from a corpus 310, by use of the first analysis device 320, the second analysis device 330, and the third analysis device 340, any combination of or all of which may be in plural or may include plural components thereof.

Regarding the first analysis device 320, the electronic device may identify a target sentence from the corpus 310. The electronic device may apply the target sentence to a text-to-speech model to obtain voice data. The voice data may be used for an operation of determining a change in voice tone, by use of the second analysis device 330. Thereafter, the electronic device may analyze a time for each word segment included in the target sentence. In detail, the electronic device may identify an utterance time of a word segment. When identifying the utterance time of the word segment, the electronic device may identify a pause time between word segments. The pause time may be used for an operation of determining a target phrase, by use of the third analysis device 340.

Regarding the second analysis device 330, the electronic device may extract information about a pitch contour of the voice data. The electronic device may extract the information about the pitch contour to identify a tone change degree of the word segment. The electronic device may use a Parselmouth library (e.g., a Praat library) to extract the information about the pitch contour. The electronic device may perform interpolation of the information about the pitch contour that is not extracted by use of the above-mentioned library. In detail, the electronic device may apply cubic spline interpolation to the voice data to identify the information about the pitch contour of the voice data, based on not identifying the information about the pitch contour from the voice data. For example, the electronic device may remove noise of the voice data and may segment the voice data into a selected, set, or predetermined voice signal analysis unit frame. The electronic device may segment the voice data to obtain at least one unit frame. The electronic device may apply short-time Fourier transform (STFT) for each unit frame to determine information about a pitch contour of the unit frame. The electronic device may apply the cubic spline interpolation to the unit frame, the information about the pitch contour of which is not determined.

Regarding the third analysis device 340, the electronic device may determine a target phrase. In detail, the electronic device may determine the target phrase by use of comparison between a pause time between the word segments and a threshold time. A detailed description associated with it will be given below with reference to FIG. 5. When the target phrase is determined, the electronic device may determine a gesture assignment candidate in the target sentence and may determine a gesture in the gesture assignment candidate. When the gesture of the gesture assignment candidate of the target sentence is determined, the electronic device may generate the target sentence as the data 350 for gesture training.

FIG. 4 is a drawing illustrating a method for identifying an utterance time of a word segment and a pause time between word segments, in an electronic device according to an embodiment of the present disclosure.

An electronic device (e.g., an electronic device 100 of FIG. 1) according to an embodiment may identify an utterance time of a word segment and a pause time between word segments, from a target sentence. For example, the electronic device may identify the utterance time of the word segment from voice data obtained by applying the target sentence to a selected, set, or predetermined text-to-speech model. In detail, the electronic device may synthesize a voice with the target sentence and may calculate an utterance time on a grapheme basis. The electronic device may add a voice utterance time for each grapheme on a word segment basis to identify the utterance time of the word segment. As a result, the electronic device may synthesize the voice with the target sentence by use of the text-to-speech model and may simultaneously calculate the utterance time, thus reducing an error in calculation and determination of the utterance time. Thereafter, when the utterance time of the word segment is identified, the electronic device may identify a pause time between word segments.

The electronic device may illustratively identify the sentence, “that Cheolsu has a dog growing up has been known.”, among sentences included in a corpus as a target sentence. For the target sentence shown in FIG. 4, the target sentence may include a first word segment, ““That Cheolsu has”, a second word segment, “a dog”, a third word segment, “growing”, a fourth word segment, “up”, and a fifth word segment, “has been known”.

The electronic device may identify an utterance time of the first word segment. Illustratively, the utterance time of the first word segment may include an interval starting at 0 seconds and ending at 0.2 seconds. The electronic device may identify an utterance time of the second word segment from the voice data. Illustratively, the utterance time of the second word segment may include an interval starting at 0.4 seconds and ending at 0.6 seconds. The electronic device may identify an utterance time of the third word segment from the voice data. Illustratively, the utterance time of the third word segment may include an interval starting at 0.9 seconds and ending at 1.2 seconds. The electronic device may identify an utterance time of the fourth word segment from the voice data. Illustratively, the utterance time of the fourth word segment may include an interval starting at 1.3 seconds and ending at 1.5 seconds. The electronic device may identify an utterance time of the fifth word segment from the voice data. Illustratively, the utterance time of the fifth word segment may include an interval starting at 1.8 seconds and ending at 2.1 seconds.

The electronic device may identify the utterance time of each of the word segments (e.g., the first to fifth word segments), thus identifying a pause time between the word segments. For example, the electronic device may determine an interval from an utterance end time point of the first word segment to an utterance start time point of the second word segment as a first pause time. The electronic device may determine an interval from an utterance end time point of the second word segment to an utterance start time point of the third word segment as a second pause time. The electronic device may determine an interval from an utterance end time point of the third word segment to an utterance start time point of the fourth word segment as a third pause time. The electronic device may determine an interval from an utterance end time point of the fourth word segment to an utterance start time point of the fifth word segment as a fourth pause time.

FIG. 5 is a drawing illustrating a method for determining a change in voice tone for each phrase, in an electronic device according to an embodiment of the present disclosure.

An electronic device (e.g., an electronic device 100 of FIG. 1) according to an embodiment may determine a change in voice tone for each phrase. For example, the electronic device may determine word segments to be included in a target phrase, among a plurality of word segments included in a target sentence. Thereafter, the electronic device may determine a change in voice tone in the target phrase, based on an utterance time of each of the word segments included in the target phrase.

The electronic device may identify a first utterance time (e.g., 0 seconds to 0.2 seconds in FIG. 5) of a first word segment (e.g., “That Cheolsu has” in FIG. 5) and a second utterance time (e.g., 0.4 seconds to 0.6 seconds in FIG. 5) of a second word segment (e.g., “a dog” in FIG. 5). The electronic device may determine a first change in voice tone (e.g., 0.2) in the first word segment, by use of the first utterance time and information about a pitch contour of the first word segment. The electronic device may determine a second change in voice tone (e.g., 0.2) in the second word segment, by use of the second utterance time and information about a pitch contour of the second word segment.

In detail, the electronic device may obtain a rate of change in voice tone at intervals of a selected, set, or predetermined unit time from the information about the pitch contour of the first word segment corresponding to the first utterance time, thus determining the first change in voice tone. For example, the electronic device may add rates of change in the information about the pitch contour of the first word segment at intervals of a unit time, thus determining the first change in voice tone. In other words, the electronic device may add all of absolute values of rates of change in voice tone (e.g., slopes) for utterance times, thus determining the first change in voice tone in the first word segment. Similarly, the electronic device may obtain a rate of change in voice tone at intervals of the predetermined unit time from the information about the pitch contour of the second word segment corresponding to the second utterance time, thus determining the second change in voice tone.

When identifying an utterance time of a word segment and a pause time between word segments, the electronic device may determine a target phrase. For example, the electronic device may determine a word segment to be included in the target phrase, based on comparison between the pause time between the word segments and a threshold time. In detail, the electronic device may include the first word segment and the second word segment in the target phrase, based on that a first pause time (e.g., 0.2) is less than the threshold time (e.g., 0.3), thus determining the target phrase. On the other hand, the electronic device may include one of the first word segment or the second word segment in the target phrase, based on that the first pause time is greater than or equal to the threshold time, thus determining the target phrase.

The electronic device may determine positions of the first word segment and the second word segment in the voice data, based on that the first pause time is less than the threshold time. The electronic device may identify a third word segment (e.g., “growing”) subsequent to the second word segment from the voice data, based on that the second word segment is subsequent to the first word segment (i.e., that the second word segment is located subsequent to the first word segment). The electronic device may determine whether to include the third word segment in the target phrase, based on comparison between a second pause time (e.g., 0.3) between the second word segment and the third word segment and the threshold time (e.g., 0.3). Illustratively, in FIG. 5, because the second pause time is the same as the threshold time, the electronic device may fail to include the third word segment in the target phrase. As a result, the electronic device may determine the target phrase (e.g., ““That Cheolsu has a dog” in FIG. 5), including the first word segment and the second word segment.

The electronic device may determine an average of the first change in voice tone (e.g., 0.2) and the second change in voice tone (e.g., 0.2), based on that the first word segment and the second word segment are included in the target phrase. Herein, because the first change in voice tone and the second change in voice tone are the same as each other, the average may be 0.2. The electronic device may determine a value obtained by applying the average to a normalization function as a change in voice tone in the target phrase. Illustratively, when the determined average is not a value of “0” to “1” or less, the electronic device may determine the average included in a predetermined interval as the change in voice tone in the target phrase by use of the normalization function. As the change in voice tone in the target phrase is close to “1”, the target phrase may be identified as an interval in which there are many changes in voice tone. However, the method for determining the change in voice tone in the target phrase in the electronic device is not limited thereto. For example, the electronic device may determine an average of a value obtained by applying a weight to the first change in voice tone and a value obtained by applying the weight to the second change in voice tone as the change in voice tone in the target phrase.

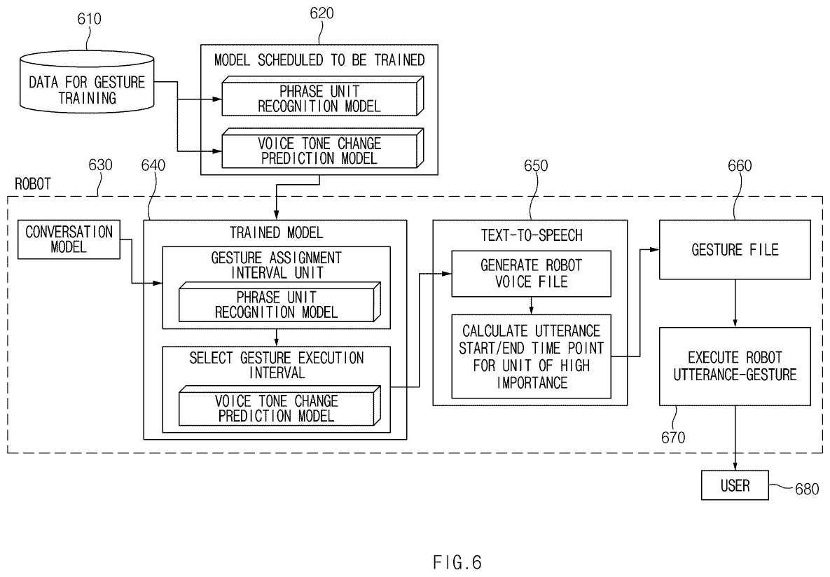

FIG. 6 is a drawing illustrating a method for generating a gesture from data for gesture training, in an electronic device according to an embodiment of the present disclosure.

An electronic device (e.g., an electronic device 100 of FIG. 1) according to an embodiment may generate a gesture from data 610 for gesture training. For example, the electronic device may identify a target sentence, including a target phrase in which a change in voice tone is determined, by use of the method for determining the target phrase, which is described above with reference to FIGS. 2 to 5. The electronic device may determine the target sentence as the data 610 for gesture training.

The electronic device may apply the data 610 for gesture training to a model 620 scheduled to be trained. For example, the model 620 scheduled to be trained may include a phrase unit recognition model and a voice tone change prediction model.

The electronic device may train the model 620 scheduled to be trained. Illustratively, the model 620 scheduled to be trained may include a neural network. The neural network may include a plurality of layers. Each layer may include a plurality of nodes. The node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

Illustratively, the forward propagation calculation in the model 620 scheduled to be trained may indicate calculation of propagating a node value based on input data, in the direction facing the output layer from the input layer of the model 620 scheduled to be trained. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

The node value of the node may be determined based on applying the activation function to the sum (e.g., weighted sum) of weighted values received from previous nodes. The parameter of the neural network may illustratively include the above-mentioned connection weight. The parameter of the neural network may be updated to be changed in a direction in which an objective function value, which will be described below, is targeted (e.g., a direction in which a loss is minimized).

In detail, the phrase unit recognition model may be a trained machine learning model for outputting a training output (e.g., whether to perform segmentation of word segments) from a training input (e.g., the data 610 for gesture training). Furthermore, the voice tone change prediction model may be a trained machine learning model for outputting a training output (e.g., a change in voice tone in a phrase) from a training input (e.g., the data 610 for gesture training).

The machine learning model (e.g. the trained phrase unit recognition model or the trained voice tone change prediction model) may be generated by use of machine learning. A learning algorithm may include, for example, but is not limited to, supervised learning, unsupervised learning, semi-supervised learning, or reinforcement learning.

The machine learning model may include a plurality of artificial neural network layers. In detail, the model 620 scheduled to be trained may include a shared layer including at least one convolution operation and a plurality of classifier layers (e.g., task-specific layers) connected with the shared layer. An artificial neural network may be, but is not limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), or deep Q-networks, or any combination thereof. Furthermore, the model 620 scheduled to be trained may include at least one of a support vector machine (SVM), a long short-term memory (LSTM), or a bidirectional long short-term memory (Bi-LSTM), or any combination thereof, but not limited to the above-mentioned examples.

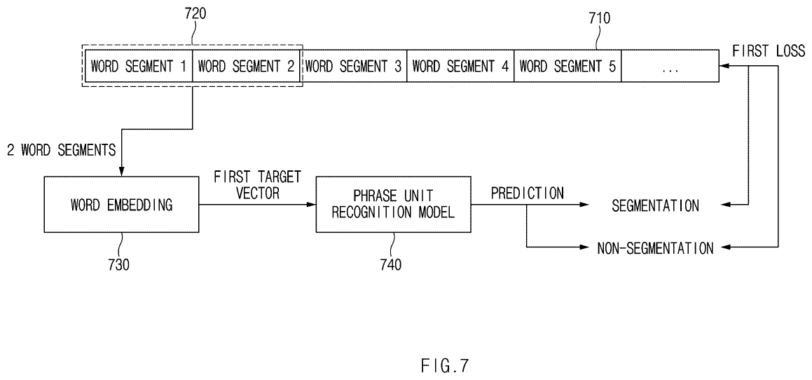

For supervised learning, the above-mentioned machine learning model may be trained based on training data including a pair of a training input and a training output mapped to the training input. For example, the machine learning model may be trained to output a training output from a training input. The machine learning model while trained may generate a temporary output in response to the training input and may be trained such that a loss between the temporary output and the training output (e.g., a training target) is minimized. A parameter of the machine learning model during a learning process (e.g., a connection weight between nodes/layers in the neural network) may be updated according to the loss. Such learning may be performed in the electronic device itself in which the machine learning model is performed or may be performed by use of a separate server. The machine learning model, the training of which is completed, (e.g., the trained phrase unit recognition model or the trained voice tone change prediction model) may be stored in a memory (e.g., a memory 120 of FIG. 1). Hereinafter, the method for training the phrase unit recognition model will be described in detail with reference to FIG. 6 and the method for training the voice tone change prediction model will be described in detail with reference to FIG. 7.

The electronic device may apply the data 610 for gesture training to the model 620 scheduled to be trained to train the phrase unit recognition model and the voice tone change prediction model. After the training is completed, the electronic device may transmit the phrase unit recognition model and the voice tone change prediction model to a robot 630.

The electronic device may identify a sentence to be output to a user 680 (hereinafter referred to as an “output sentence”), from a conversation model of the robot 630. The electronic device may apply the output sentence to the phrase unit recognition model, which determines a gesture assignment interval unit, in a trained model 640. The electronic device may obtain phrases included in the output sentence, based on applying the output sentence to the phrase unit recognition model.

The electronic device may apply each of the phrases included in the output sentence to the voice tone change prediction model, based on obtaining the phrases included in the output sentence from the phrase unit recognition model. The electronic device may obtain a change in voice tone in each of the input phrases, based on applying each of the phrases included in the output sentence to the voice tone change prediction model.

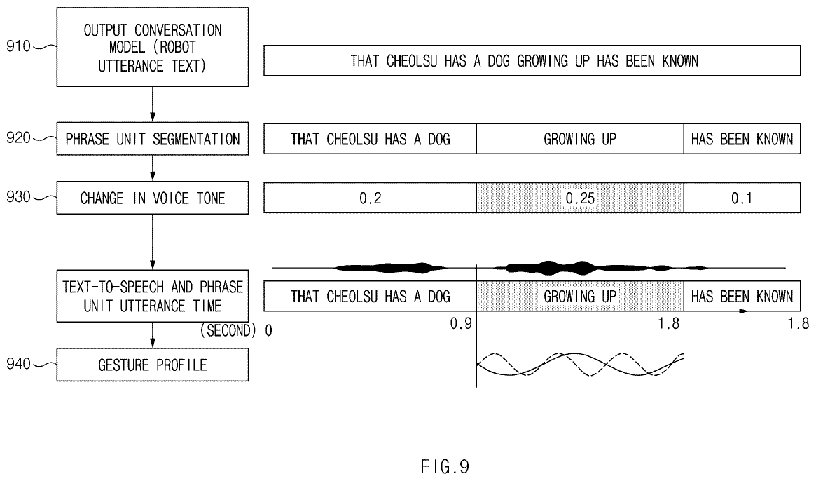

The electronic device may perform text-to-speech 650 of the output sentence, based on that the change in voice tone in each of the phrases included in the output sentence is determined. In detail, the electronic device may generate a voice file to be output by the robot 630, for each phrase in which the change in voice tone is determined. Thereafter, the electronic device may determine an utterance start time point and an utterance end time point of a phrase with high importance, with reference to the change in voice tone in each of the phrases included in the output sentence. As a result, the electronic device may assign and provide a gesture to the phrase with high importance in the output sentence. The method for assigning the gesture to one of the plurality of phrases in the electronic device will be described in detail below with reference to FIG. 9.

When the gesture is assigned to the phrase with the high importance in the output sentence, the electronic device may generate a gesture file 660 about the gesture of the phrase. The electronic device may control the robot 630 to utter a voice to the user 680 (i.e., output a voice and a gesture), by use of the gesture file 660.

FIG. 7 is a drawing illustrating a method for training a phrase unit recognition model, in an electronic device according to an embodiment of the present disclosure.

An electronic device (e.g., an electronic device 100 of FIG. 1) according to an embodiment may identify a target window 720 from training data 710. The target window 720 may include a first word segment and a second word segment.

The electronic device may obtain a first target vector with the number of selected, set, or predetermined dimensions, by use of word embedding 730 of the target window 720. The first target vector may be a vector including values obtained by abstracting a feature of the target window 720. For example, the electronic device may generate a 100-dimensional vector for every word segment included in the target window 720, by use of the word embedding 730 of the target window 720.

The electronic device may apply the first target vector to a phrase unit recognition model 740 to obtain an output (e.g., segmentation and non-segmentation) indicating whether to perform segmentation of the word segments included in the target window 720. The electronic device may train the phrase unit recognition model 740, based on a first loss obtained by use of comparison between the output and the training data 710 (e.g., a target sentence). Illustratively, the first loss may include binary cross entropy. Thereafter, the electronic device may apply a vector through word embedding of a window including the second word segment and a third word segment to the phrase unit recognition model 740 to train the phrase unit recognition model 740.

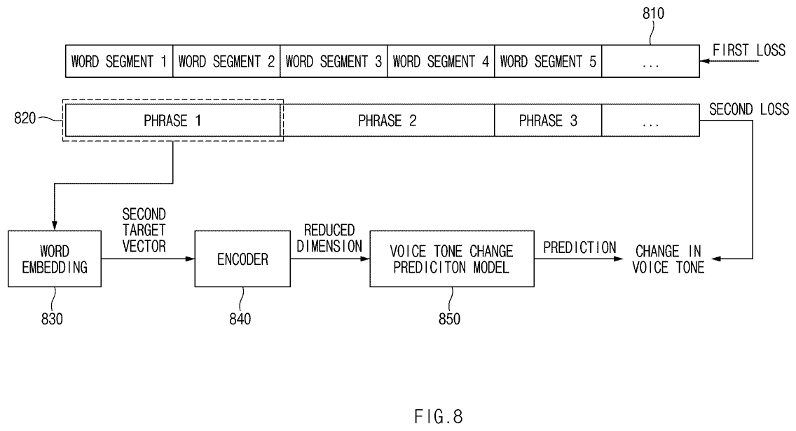

FIG. 8 is a drawing illustrating a method for training a voice tone change prediction model, in an electronic device according to an embodiment of the present disclosure.

An electronic device (e.g., an electronic device 100 of FIG. 1) according to an embodiment may identify a target phrase 820 from training data 810. The target phrase 820 may include at least one of phrases included in the training data 810. The electronic device may obtain a second target vector including vectors with the number of selected, set, or predetermined dimensions for every word segment included in the target phrase 820, by use of word embedding 830 of the target phrase 820. For example, the second target vector may be a vector including values obtained by abstracting a feature of the target phrase 820.

The electronic device may apply the second target vector to an encoder 840 for reducing a dimension of an input target to reduce a dimension of the second target vector. The encoder 840 may be, but is not limited to, one of a principal component analysis (PCA) model or an auto encoder model.

The electronic device may apply the second target vector (i.e., the second target vector, the dimension of which is reduced) applied to the encoder 840 to a voice tone change prediction model 850 to obtain a temporary change in voice tone in the target phrase 820. The electronic device may train the voice tone change prediction model 850, based on a second loss obtained by use of comparison between the temporary change in voice tone in the target phrase 820 and a change in voice tone in the target phrase 820 (e.g., a change in voice tone in a phrase in FIG. 5). Illustratively, the second loss may include a mean squared error (MSE) loss.

FIG. 9 is a drawing illustrating a method for determining a gesture in a target sentence, in an electronic device according to an embodiment of the present disclosure.

An electronic device (e.g., an electronic device 100 of FIG. 1) according to an embodiment may identify a target sentence 910 that is an output of a conversation model and is simultaneously a robot utterance text. The electronic device may apply the target sentence 910 to a phrase unit recognition model (e.g., a phrase unit recognition model 740 of FIG. 7) to perform segmentation 920 of the target sentence 910.

The electronic device may determine a change in voice tone in each of phrases included in the target sentence 910, based on that the segmentation 920 of the target sentence 910 is performed. For example, the electronic device may apply each of the phrases included in the target sentence 910 to a voice tone change prediction model (e.g., a voice tone change prediction model 850 of FIG. 5) to determine a change in voice tone in each of the phrases included in the target sentence 910.

The electronic device may determine a phrase with a largest change in voice tone among the phrases included in the target sentence 910 as a gesture assignment candidate corresponding to a gesture execution interval of the target sentence 910, based on that the change in voice tone in each of the phrases included in the target sentence 910 is determined. Referring to FIG. 9, the phrase with the largest change in voice tone among the phrases included in the target sentence 910 may be “growing up”.

The electronic device may determine a gesture of the gesture assignment candidate, based on a gesture type corresponding to the gesture assignment candidate. For example, the electronic device may determine a gesture type of the gesture assignment candidate, “growing up”. In detail, the electronic device may request a server (e.g., a server 140 of FIG. 1) to transmit the above-mentioned gesture type, thus determining the gesture of the gesture assignment candidate. The gesture type may be obtained by inputting key words included in the gesture assignment candidate to a gesture database stored in the server.

The electronic device may allow the gesture of the gesture assignment candidate to correspond to an utterance time of the gesture assignment candidate, thus generating a gesture of a robot scheduled to output the target sentence 910. For example, the electronic device may generate a gesture profile 940 about a gesture to be applied to the target sentence 910. The electronic device may execute voice data of the target sentence 910 and the gesture profile 940 by use of the robot, thus providing a user with an output of the target sentence 910 including the gesture.

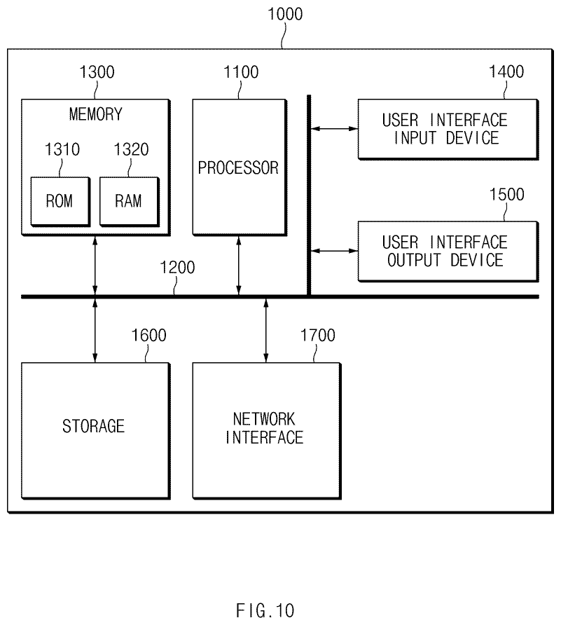

FIG. 10 is a drawing illustrating a computing system associated with an electronic device or a control method thereof according to an embodiment of the present disclosure.

Referring to FIG. 10, a computing system 1000 about the electronic device or the control method thereof may include at least one processor 1100, a memory 1300, a user interface input device 1400, a user interface output device 1500, storage 1600, and a network interface 1700, which can be connected with each other via a bus 1200, any combination of or all of which may be in plural or may include plural components thereof.

The processor 1100 may be a central processing unit (CPU) or a semiconductor device that processes instructions stored in storage medium(s), such as the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory and/or the storage) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to example embodiments and the accompanying drawings, the present disclosure is not necessarily limited thereto, but may be variously modified and altered by those skilled in the art to which the present disclosure pertains, including equivalents thereof, without departing from the spirit and scopes of the present disclosure claimed in the following claims.

The above-described example embodiments may be implemented with hardware components, software components, and/or a combination of hardware components and software components. For example, the devices, methods, and components described in the example embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It can be understood by those skilled in the art that although a single processing unit may be illustrated for convenience of understanding, the processing unit may include a plurality of processing elements and/or a plurality of types of processing elements, together or separated. For example, the processing unit may include a plurality of processors or one processor and one controller. Also, the processing unit may have a different processing configuration, such as a parallel processor.

Software may include computer programs, codes, instructions, or one or more combinations thereof, and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner or distributed manner. Software and data may be recorded in one computer-readable storage media.

The methods according to embodiments may be implemented in the form of program instructions that may be executed through various computer implementations and may be recorded in computer-readable media. The computer-readable media may include program instructions, data files, data structures, and the like, alone or in combination, and the program instructions recorded on the media may be specially designed and configured for an example and/or may be known and usable to those skilled in the art of computer software. Examples of computer-readable media can include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions can include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the example embodiments herein are described with reference to restricted drawings, it may be understood to one skilled in the art that the example embodiments can be variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

A description will be given of advantages and potential effects of the electronic device and the control method thereof according to an embodiment of the present disclosure.

According to an embodiment of the present disclosure, the electronic device may determine a change in voice tone in the target phrase, based on information about a pitch contour of voice data obtained by applying a target sentence to a text-to-speech model and an utterance time of each of word segments, thus generating a gesture suitable for an utterance of a robot based on the change in voice tone.

According to an embodiment of the present disclosure, the electronic device may apply cubic spline interpolation to the voice data to obtain information about a pitch contour, based on not identifying the information about the pitch contour from the voice data, thus obtaining a change in voice tone in a word phrase in which the pitch contour is not identified.

According to an embodiment of the present disclosure, the electronic device may determine a phrase with the largest change in voice tone among phrases included in the target sentence as a gesture assignment candidate of the target sentence, thus providing natural interaction with the user by use of natural speech-gesture generation of the robot.

Various advantages and effects can be ascertained directly or indirectly through the present disclosure. Therefore, other implements, other embodiments, and equivalents to claims can be within the scopes of the following claims.

Therefore, example embodiments of the present disclosure are not intended to limit the technical spirit of the present disclosure, but rather are provided for illustrative purposes. The scopes of the present disclosure can be construed on the basis of the accompanying claims, and all technical ideas within scopes equivalent to the claims can be included in the scopes of the present disclosure.

What is claimed is:

1. An electronic device, comprising:
one or more processors; and
a storage medium storing computer-readable instructions that, when executed by the one or more processors, enable the one or more processors to:
identify a first word segment being a first unit on grammar and a second word segment being a second unit on grammar from a target sentence included in a corpus,
determine a target phrase including the first word segment and the second word segment, based on comparing a first pause time between the first word segment and the second word segment and a threshold time, and
determine a change in voice tone in the target phrase, based on information about a pitch contour of voice data obtained by applying the target sentence to a text-to-speech model and an utterance time of each word segment included in the target phrase.

2. The device of claim 1, wherein the instructions further enable the one or more processors to:
identify a first utterance time of the first word segment and a second utterance time of the second word segment from the voice data;
determine a first change in voice tone in the first word segment by use of the first utterance time and information about a first pitch contour of the first word segment; and
determine a second change in voice tone in the second word segment by use of the second utterance time and information about a second pitch contour of the second word segment.

3. The device of claim 2, wherein the instructions further enable the one or more processors to:
obtain a first rate of change in voice tone at intervals of a set unit time from the first pitch contour of the first word segment corresponding to the first utterance time to determine the first change in voice tone; and
obtain a second rate of change in voice tone at the intervals of the set unit time from the second pitch contour of the second word segment corresponding to the second utterance time to determine the second change in voice tone.

4. The device of claim 2, wherein the instructions further enable the one or more processors to:
determine an average of the first change in voice tone and the second change in voice tone, based on the first word segment and the second word segment being included in the target phrase; and
determine a value obtained by applying the average to a normalization function as a target phrase change in voice tone for the target phrase.

5. The device of claim 1, wherein the instructions further enable the one or more processors to:
include the first word segment and the second word segment in the target phrase, based on the first pause time being less than the threshold time; and
include one of the first word segment or the second word segment in the target phrase, based on the first pause time being greater than or equal to the threshold time.

6. The device of claim 5, wherein the instructions further enable the one or more processors to:
determine positions of the first word segment and the second word segment in the voice data, based on the first pause time being less than the threshold time;
identify a third word segment subsequent to the second word segment from the voice data, based on the second word segment being subsequent to the first word segment; and
determine whether to include the third word segment in the target phrase, based on comparing a second pause time between the second word segment and the third word segment and the threshold time.

7. The device of claim 1, wherein the instructions further enable the one or more processors to:
obtain a first target vector with a first number of dimensions, by use of word embedding of a target window including the first word segment and the second word segment;
apply the first target vector to a phrase unit recognition model to obtain an output indicating whether to perform segmentation of word segments included in the target window; and
train the phrase unit recognition model, based on a first loss obtained by use of comparing the output and the target sentence.

8. The device of claim 1, wherein the instructions further enable the one or more processors to:
obtain a second target vector including vectors with a second number of dimensions for every word segment included in the target phrase, by use of word embedding of the target phrase;
apply the second target vector to an encoder for reducing an input target dimension of an input target to reduce the second number of dimensions of the second target vector;
apply the second target vector after applied to the encoder to a voice tone change prediction model to obtain a temporary change in voice tone in the target phrase; and
train the voice tone change prediction model, based on a second loss obtained by use of comparing the temporary change in voice tone in the target phrase and a target phrase change in voice tone for the target phrase.

9. The device of claim 1, wherein the instructions further enable the one or more processors to:
determine a largest phrase having a largest change in voice tone among collective phrases included in the target sentence as a gesture assignment candidate, wherein the gesture assignment candidate corresponds to a gesture execution interval of the target sentence, based on a change in voice tone in each phrase included in the target sentence being determined;
determine a gesture of the gesture assignment candidate, based on a gesture type corresponding to the gesture assignment candidate; and
allow the gesture to correspond to an utterance time of the gesture assignment candidate to generate a robot gesture of a robot scheduled to output the target sentence.

10. The device of claim 1, wherein the instructions further enable the one or more processors to apply cubic spline interpolation to the voice data to identify the information about the pitch contour.

11. A control method, comprising:
identifying a first word segment being a first unit on grammar and a second word segment being a second unit on grammar from a target sentence included in a corpus;
determining a target phrase including the first word segment and the second word segment, based on comparing a first pause time between the first word segment and the second word segment and a threshold time; and
determining a change in voice tone in the target phrase, based on information about a pitch contour of voice data obtained by applying the target sentence to a text-to-speech model and an utterance time of each word segment included in the target phrase.

12. The method of claim 11, wherein the determining of the target phrase includes:
identifying a first utterance time of the first word segment and a second utterance time of the second word segment from the voice data;
determining a first change in voice tone in the first word segment by use of the first utterance time and information about a first pitch contour of the first word segment; and
determining a second change in voice tone in the second word segment by use of the second utterance time and information about a second pitch contour of the second word segment.

13. The method of claim 12, wherein the determining of the target phrase includes:
obtaining a first rate of change in voice tone at intervals of a set unit time from the first pitch contour of the first word segment corresponding to the first utterance time to determine the first change in voice tone; and
obtaining a second rate of change in voice tone at the intervals of the set unit time from the second pitch contour of the second word segment corresponding to the second utterance time to determine the second change in voice tone.

14. The method of claim 12, further comprising:
determining an average of the first change in voice tone and the second change in voice tone, based on the first word segment and the second word segment being included in the target phrase; and
determining a value obtained by applying the average to a normalization function as a target phrase change in voice tone for the target phrase.

15. The method of claim 11, wherein the determining of the target phrase includes:
including the first word segment and the second word segment in the target phrase, based on the first pause time being less than the threshold time; and
including one of the first word segment or the second word segment in the target phrase, based on the first pause time being greater than or equal to the threshold time.

16. The method of claim 15, wherein the determining of the target phrase includes:
determining positions of the first word segment and the second word segment in the voice data, based on the first pause time being less than the threshold time;
identifying a third word segment subsequent to the second word segment from the voice data, based on the second word segment being subsequent to the first word segment; and
determining whether to include the third word segment in the target phrase, based on comparing a second pause time between the second word segment and the third word segment and the threshold time.

17. The method of claim 11, further comprising:
obtaining a first target vector with a first number of dimensions, by use of word embedding of a target window including the first word segment and the second word segment;
applying the first target vector to a phrase unit recognition model to obtain an output indicating whether to perform segmentation of word segments included in the target window; and
training the phrase unit recognition model, based on a first loss obtained by use of comparing the output and the target sentence.

18. The method of claim 11, further comprising:
obtaining a second target vector including vectors with a second number of dimensions for every word segment included in the target phrase, by use of word embedding of the target phrase;
applying the second target vector to an encoder for reducing an input target dimension of an input target to reduce the second number of dimensions of the second target vector;
applying the second target vector after applied to the encoder to a voice tone change prediction model to obtain a temporary change in voice tone in the target phrase; and
training the voice tone change prediction model, based on a second loss obtained by use of comparing the temporary change in voice tone in the target phrase and a target phrase change in voice tone for the target phrase.

19. The method of claim 11, further comprising applying cubic spline interpolation to the voice data to identify the information about the pitch contour.

20. A control method, comprising:
identifying a first word segment being a first unit on grammar and a second word segment being a second unit on grammar from a target sentence included in a corpus;
determining a target phrase including the first word segment and the second word segment, based on comparing a first pause time between the first word segment and the second word segment and a threshold time;
determining a change in voice tone in the target phrase, based on information about a pitch contour of voice data obtained by applying the target sentence to a text-to-speech model and an utterance time of each word segment included in the target phrase;
determining a change in voice tone in each of collective phrases included in the target sentence;
determining a largest phrase having a largest change in voice tone among the collective phrases included in the target sentence as a gesture assignment candidate, wherein the gesture assignment candidate corresponds to a gesture execution interval of the target sentence, based on the determining of the change in voice tone in each of the collective phrases included in the target sentence;
determining a gesture of the gesture assignment candidate, based on a gesture type corresponding to the gesture assignment candidate; and
designating the gesture to correspond to an utterance time of the gesture assignment candidate to generate a robot gesture of a robot scheduled to output the target sentence.
